(19) United States
(12) Patent Application Publication
(10) Pub. No.: US 2023/0078959 A1
(43) Pub. Date: Mar. 16, 2023

(54) LIQUID ANODE BASED MOLTEN OXIDE ELECTROLYSIS/ THE PRODUCTION OF OXYGEN FROM ELECTROLYSIS OF MOLTEN OXIDE

(71) Applicant: HELIOS PROJECT LTD., Hod Hasharon (IL)

(72) Inventor: Jonathan GEIFMAN, Hod Hasharon (IL)

(73) Assignee: HELIOS PROJECT LTD., Hod Hasharon (IL)

(21) Appl. No.: 17/800,819

(22) PCT Filed: Apr. 20, 2021
(86) PCT No.: PCT/IL2021/050445

§ 371 Date: Aug. 18, 2022

Related U.S. Application Data
(60) Provisional application No. 62/978,873, filed on Feb. 20, 2020.

(51) Int. Cl. C25B 9/30; C25B 1/02; C25B 9/67; C25B 11/042

(52) U.S. Cl. CPC C25B 9/303; C25B 1/02; C25B 9/67; C25B 11/042

(57) ABSTRACT

It is the object of the present invention to present a cell for extracting oxygen from lunar regolith via Molten Oxide Electrolysis, comprising (i) a cathode, (ii) an anode and (iii) a crucible, wherein the anode is characterized as at least partially liquid. The anode may be constructed from palladium, lead, silver, gold, platinum tantalum, or from a mixture.

### FIELD

The application is in the field of molten oxide electrolysis oxygen and metals production

### BACKGROUND

Molten oxides electrolysis (MOE) is a process in which high temperature molten oxides are reacted to separate the metal from oxygen by the means of an electrochemical process. The two components are then collected separately and stored for further individual use. In electrochemical process the essentials elements consist of electrodes, electrolyte, and power source can come in different phases (e.g. solid, liquid or gas). Electrodes must be electronically conductive and can be used in solid, liquid or gas form. Basic two electrodes are mandatory in the electrochemical process:
The anode, where current is collected.
The cathode, where current is dispensed.

U.S. Pat. No. 8,764,962 discloses an electrolytic extraction method from an oxide feedstock compound. The feedstock compound is dissolved in an oxide melt in an electrolytic cell, in contact with a cathode and an anode. During electrolysis the target element is deposited at a liquid cathode and coalesces therewith. Oxygen is evolved on an anode bearing a solid oxide layer, in contact with the oxide melt, over a metallic anode substrate.

U.S. Pat. No. 5,536,378 discloses a reactor apparatus for production of Lunar oxygen, using feed stocks comprising a particulate hydrogen-reducible enriched feed in the size range from about 20-200 microns, containing 80-90% Lunar ilmenite (FeTiO3) and ferrous Lunar agglutinates. The reactor apparatus has three vertically spaced fluidized zones with downcomers from the upper to the central fluidized zone and openings for introducing a hydrogen-containing gas stream through the lower fluidized zone. A solid-to-gas RF-dielectric heater has a ceramic honeycomb with small parallel channels separated by thin, ceramic walls and electrodes surrounding the honeycomb connected to an external RF power source for heating the gas stream to a reducing reaction temperature. A top inlet introduces the enriched feed into the upper fluidized zone for fluidization therein and flow into middle and lower fluidized zones countercurrent to the flow of the gas stream. A solid-state electrolyzer is composed of calcium oxide- or yttrium oxide-stabilized zirconia ceramic fabricated by sintering or slipcasting into a perforated cylindrical shape having platinum electrodes on outer and inner longitudinal surfaces thereof. The electrolyzer cylinder is mounted inside two disk-shaped, impermeable ceramic baffles and centered inside a refractory-lined metal pressure shell. Gaseous effluent containing an equilibrium amount of water from the central fluidized zone passes through the electrolyzer for continuous electrolysis of the water. Apparatus is provided for separating oxygen from the electrolyzer and recycling hydrogen to the gas stream.

U.S. Pat. No. 7,935,176 describes a facility and process capable of extracting oxygen in extraterrestrial environments from materials available in extraterrestrial environments, for example, on planets, planetoids, etc. The facility extracts oxygen from a mineral-containing solid material and is configured to form a free-falling molten stream of the solid material, evaporate at least a portion of the molten stream and produce a vapor containing gaseous oxygen, create a supersonic stream of the vapor, condense constituents of the supersonic stream to form particulates within the supersonic stream, separate the gaseous oxygen from the particulates, and then collect the gaseous oxygen.

U.S. Pat. No. 4,997,533 discloses that oxygen and metallic iron are produced from an iron oxide-containing mineral, such as ilmenite, by extracting iron from the mineral with hydrochloric acid, separating solid residue from the resulting solution and drying same, electrolyzing the separated, iron chloride-containing solution to produce electrolytic iron and chlorine gas, combining the chlorine gas with water recovered from the drying and/or iron chloride-containing solution electrolysis steps of regenerate hydrochloric acid and recycling the hydrochloric acid to the extraction step. In an alternate embodiment, the chlorine gas is reacted with recovered water in the presence of a catalyst to produce hydrochloric acid which is recycled to the extraction step, thereby eliminating the need for water electrolysis and a separate hydrochloric acid regeneration step. In another alternate embodiment, electrolysis of the iron chloride-containing solution is operated to produce oxygen instead of chlorine gas at the anode and hydrochloric acid is generated concurrently with plating of iron at the cathode.

Patent application WO2018059902A1 discloses an invention comprising supplying a high-temperature ultra-high vacuum furnace, the sole chamber of which is metal, in which an electrically conductive crucible, preferably made of tantalum, is placed onto an insulating support, preferably a ceramic, and is induction heated by a winding wound around the crucible. The insulating tube, preferably made of quartz that is arranged between the induction winding and the crucible, advantageously acts as a surface on which the condensable species can condense.

U.S. Pat. No. 5,227,032 discloses methods for producing oxygen from metal oxides bearing minerals, e.g. ilmenite, the process including producing a slurry of the minerals and hot sulfuric acid, the acid and minerals reacting to form sulfates of the metal, adding water to the slurry to dissolve the minerals into an aqueous solution, separating the first aqueous solution from unreacted minerals from the slurry, and electrolyzing the aqueous solution to produce the metal and oxygen; and in one aspect, a process for producing a slurry with ferrous sulfate therein by reacting ilmenite and hot sulfuric acid, adding water to the slurry to dissolve the ferrous sulfate into an aqueous solution, separating the aqueous solution from the slurry, and electrolyzing the aqueous solution to produce iron and oxygen.

There exists a long-felt need for a method of producing oxygen and metals from metal oxides.

### SUMMERY

It is the object of the present invention to present a cell for extracting oxygen from lunar regolith, comprising
a. a cathode;
b. an anode;
c. a crucible;
   wherein the anode is characterized as at least partially liquid.

It is another object of the present invention to present a cell as presented in any of the above, wherein the crucible is constructed from a material characterized by at least one of the following:
a. high chemical resistance to molten lunar regolith;
b. does not decompose at a temperature of up to 2200° C.;
c. does not evaporate at a temperature of up to 2200° C.;

It is another object of the present invention to present a cell as presented in any of the above, wherein the crucible is constructed from a material selected from a group consisting of zirconium oxide, hafnium oxide, boron nitride, silicon nitride, tantalum hexaboride, hafnium boride, magnesium oxide, silicon carbide, silicon nitride and zirconium diboride.

It is another object of the present invention to present a cell as presented in any of the above, wherein the crucible further comprises a solid (un-melted) layer of lunar regolith.

It is another object of the present invention to present a cell as presented in any of the above, wherein the anode is characterized by at least one of the following:
a. a reduction potential of at least 0.8 volts;
b. being inert to oxygen at temperature of up to 2200° C.;
c. having a slow diffusion rates with molten regolith;
d. not forming emulsions with molten regolith;
e. having a boiling point of at least 2200° C.;
f. having a liquid density higher than that of molten regolith;
g. having a liquid density lower than that of the molten regolith.

It is another object of the present invention to present a cell as presented in any of the above, wherein the anode is selected from a group consisting of palladium, lead, silver, gold, platinum tantalum, or as an alloy of the materials.

It is another object of the present invention to present a cell as presented in any of the above, wherein the anode is characterized as a liquid, a solution, an emulsion or as a suspension.

It is another object of the present invention to present a cell as presented in any of the above, wherein the cathode is selected from a group consisting of Mo, Pt, Ir, Rh and Fe.

It is another object of the present invention to present a cell as presented in any of the above, wherein the cathode is characterized by at least one of the following:
a. having a high current density;
b. having a surface area;
c. having good electronic conductivity;
d. having high temperature resistance;
e. having low reactivity with molten regolith;

It is another object of the present invention to present a cell as presented in any of the above, additionally comprising a system for heating the cell to a temperature of 2000° C.

It is another object of the present invention to present a cell as presented in any of the above, additionally comprising means for collecting and or storing the oxygen.

It is another object of the present invention to present a cell as presented in any of the above, additionally comprising a system removing used lunar regolith.

It is another object of the present invention to present a cell as presented in any of the above, additionally comprising a system adding the lunar regolith to the cell.

It is another object of the present invention to present a cell as presented in any of the above, additionally comprising a system for heating the lunar regolith.

It is another object of the present invention to present a cell as presented in any of the above, additionally comprising a system for generating an electric current.

It is the object of the present invention to present a method of obtaining oxygen from lunar regolith, comprising steps of:
a. obtaining a cell, comprising:
   a. a cathode;
   b. an anode;
   c. a crucible;
b. adding lunar regolith to the cell;
c. heating the regolith to its melting point;
d. generating an electric current of 2-10 volts;
e. collecting oxygen from the anode;
   wherein the anode is characterized at least partially as a liquid.

It is another object of the present invention to present a method as presented in any of the above, wherein the lunar regolith is characterized as comprising iron oxide.

It is another object of the present invention to present a method as presented in any of the above, additionally comprising a step of removing used lunar regolith.

It is another object of the present invention to present a method as presented in any of the above, wherein the crucible is constructed from a material characterized by at least one of the following:
a. high chemical resistance to the molten lunar regolith;
b. does not decompose at a temperature of up to 2200° C.;
c. does not evaporate at a temperature of up to 2200° C.

It is another object of the present invention to present a method as presented in any of the above, wherein the anode is characterized by at least one of the following:
a. a reduction potential of at least 0.8 volts;
b. being inert to oxygen at temperature of up to 2000° C.;
c. having a slow diffusion rates with molten regolith;
d. not forming emulsions with molten regolith;
e. having a boiling point of at least 2200° C.;
f. having a liquid density higher than that of molten regolith;
g. having a liquid density lower than that of the molten regolith.

It is another object of the present invention to present a method as presented in any of the above, wherein the anode is selected from a group consisting of palladium, lead, silver, gold, platinum tantalum, or any of their alloys.

It is another object of the present invention to present a method as presented in any of the above, wherein the cathode is a transition metal.

It is another object of the present invention to present a method as presented in any of the above, wherein the cathode is selected from a group consisting of Mo, Pt, Ir, Rh and Fe.

It is another object of the present invention to present a method as presented in any of the above, wherein the cathode is characterized by at least one of the following:
a. having a high current density;
b. having a surface area;
c. having good electronic conductivity;
d. having high temperature resistance;
e. having low reactivity with molten regolith;

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention wherein:

FIG. 1—presents a schematic of an electrochemical cell for the extraction of pure aluminum from alumina.

FIG. 2—presents a schematic of electrolytic cell for the extraction of oxygen and iron from regolith.

FIG. 3(a,b)—presents a schematic of electrolytic cells for the extraction of oxygen and iron from regolith

FIG. 4(a,b)—shows the system of example 1.

FIG. 5—showing the reduction of lunar regolith simulant of example 1.

### DETAILED DESCRIPTION OF THE PRESENT INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

In this application the term “molten reductive electrolysis” (MRE) refers to the process of reducing melted oxides.

In this application the term “Molten Oxide Electrolysis” (MOE) refers to the electrolytic decomposition of a metal oxide(s), producing metal (as a liquid) and oxygen (as a gas). In this application the term “Lunar regolith simulant” refers to a deposition of unconsolidated, loose, heterogeneous superficial deposits covering solid rock, such as the moon. The regolith often comprises dust, broken rocks, and other related materials and is present on. Lunar regolith is generally 4-5 m thick in mare areas and 10-15 m in the older highland regions. The term “Lunar soil” is often used to refer to a finer fraction of the lunar regolith, but is can often be used interchangeably. The term Lunar dust is generally used to refer to even finer materials than lunar soil.

The following abbreviations are used herein:

Unless otherwise stated, all concentrations expressed as weight-to-weight percentage.

Unless otherwise stated, with reference to numerical quantities, the term “about” refers to a tolerance of ±25% of the stated nominal value.

Unless otherwise stated, all numerical ranges are inclusive of the stated limits of the range.

### DESCRIPTION OF THE PREFERRED EMBODIMENT OF THE PRESENT INVENTION

The molten oxides electrolysis (MOE) process is conducted at high temperature, to separate the metal and oxygen from the molten oxides by an electrochemical process. The two products are separated, collected and stored for further individual use. In electrochemical process the essentials elements consist of electrodes, electrolyte, and power source can come in different phases (e.g. solid, liquid or gas). Electrodes must be electronically conductive and can be in used in solid, liquid or gas form. Basic two electrodes are mandatory in the electrochemical process: the anode (through which the conventional current exits the process) and the cathode (through which the enters the process).

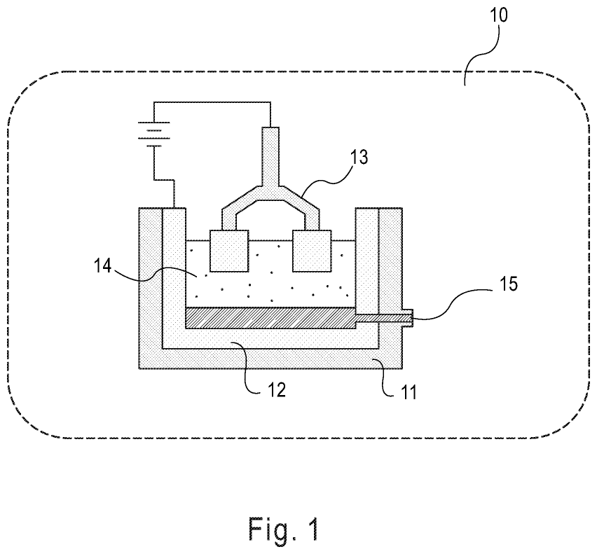

The most common liquid electrodes process is referred to as the ‘Hall-Haroult’ is a common liquid electrodes process used for the production of aluminum. The process is based on the electrolysis of alumina (Al₂O₃) to produce aluminum on the cathode and oxygen on the anode. In this system, the alumina is mixed with cryolite (Na₃AlF₆), which lowers the alumina's melting point and acts as its solvent. The cell is operated at 980° C. where the alumina is dissolved in liquid cryolite 14. Reference is made to FIG. 1, showing a cell 10, with a crucible 11 constructed from steel, with the bottom coated with graphite 12, that acts as the cathode in the electrolysis process. The anode is constructed of several rods of graphite and positioned at the top of the cell 13. Pure aluminum produced on the cathode has higher density as that of molten cryolite, and therefor sinks to the bottom of the cell 15, where it spills out, and it is collected and cooled for further use. On the Anode, the oxidation of oxygen anions occurs, producing molecular oxygen. Since the anode is coated with a layer of carbon, in this case, most of the oxygen produced is further reacted to produce carbon dioxide. The optimum current density applied in the electrolysis is around 1 A cm⁻² with a total cell current of 150-300 kA and a cell voltage of 4.0 to −4.5V.

### Producing Oxygen and Iron in a Three-Layered Liquid Cell

Iron production is often conducted inside a half-liquid cell, with a coal anode and a liquid iron cathode. The process is highly polluting, due to the high amounts of carbon dioxide released from the anode as a biproduct from the oxygen formation on the carbon anode. Substituting the coal anode with an inert material (such as Iridium, Thoriated Tungsten, Rhodium, Silver, Palladium, Gold, Platinum, Ruthenium, Niobium) which does not react with the oxygen formed on the anode, can allow for clean(er) production of iron.

Extraction of iron using molten oxide electrolysis typically conducted at a temperature range of 1600-1700° C. After liquidation is completed, electrolysis is performed. During so, liquid iron accumulates around the cathode and oxygen around the anode.

Liquid iron oxide electrolysis is a process in which the molten iron oxide is degraded to its basic elements—iron (which accumulates on the cathode) and oxygen (which accumulates on the anode). An example for the reaction (in the case of Fe₃O₄ and FeO) could be described as:

⅓Fe₃O₄(l)⇄Fe₍ₗ₎+⅔O₂(g,1 atm)(at T=1811 K)

2FeO(l)⇄2Fe₍ₗ₎+O₂(g,1 atm)(at T=1811 K)

For the MRE process, the melting temperature is dependent on the composition of the stock material, the lunar regolith. This can affect the energy required to heat and subsequently electrolyze the molten regolith. Lunar regolith is mainly composed (99%) of 7 compounds: Oxygen O (41-45%), Silicon Si (20-25%), Aluminum Al (˜15%), Calcium Ca (˜10%), Iron Fe (˜0.5%), Magnesium Mg and Titanium Ti (by mass).

The exact composition of the regolith can change and is commonly affected by the location and depth of the sample. Highland regolith has a significantly higher melting temperature (˜1600° C.), and is deficient in elements, such as iron and titanium, which are more easily reduced via MRE. Regolith in the mare terrains has a substantially lower melting point (˜1200° C.), and has an iron content of up to 20% (by wt.).

The Lunar regolith is chemically reduced, partially due to the constant bombardment of the lunar surface with protons and solar radiation. Iron on the Moon is often found in the elemental (0) and cationic (+2) oxidation states. At lunar atmospheric conditions magnetite does not exist, due to the low energy conditions, and FeO is the most common form of iron oxide.

### System Design

In order to withstand the high temperature (approximately 1700° C.) the cell materials must be construed from a stable and chemically resistant material, adapted to the specific reaction environment. In addition, the Molten regolith is chemically aggressive. To protect the reactor walls from corrosion, the electrolysis should be performed in regolith of which only the core is molten by the Joule's heat of the electrolysis and the outer shell remains solid and insulates towards the reactor wall.

The crucible must be constructed from a material that can withstand the high temperatures of the reaction while withholding its shape (such as Zirconium oxide, hafnium oxide, boron nitride, silicon nitride, tantalum hexaboride, hafnium boride, magnesium oxide, silicon carbide, silicon nitride, zirconium boride etc.). In some embodiments, the crucible further comprises a solid (un-melted) layer of stock material (regolith) that does not melt and/or react, protecting the crucible from the Molten regolith it can be described as ‘cold wall’ melting.

The crucible can be built by any standard method of building ultra-high refractory materials ceramics. The methods include for powder preparation—solid state reaction, co-precipitation, sol-gel, spray pyrolysis, emulsion synthesis. The shape forming processes include pressing, casting, plastic forming, colloidal processing. Sintering processes includes pressure less, hot press, hot isostatic press. Finishing processes includes mechanical, laser, water jet, ultrasonic. The possible materials can be from Zirconium oxide, hafnium oxide, boron nitride, silicon nitride, tantalum hexaboride, hafnium boride, magnesium oxide, silicon carbide, silicon nitride, zirconium diboride.

The cathode is the initial current donor and needs to support high current density and high temperature and to not to react with the liquid iron or electrolyte around it. In some embodiments, the cathode comprises a liquid iron coating, produced during the MOE process and deposed on the cathode.

The anode is often constructed from a refractory metal, being resistant to decomposition by the heat, pressure and chemicals in the reaction, retaining its strength and form at during the reaction. Iridium and rhodium are commonly used. Carbon (such as carbon graphite) are often used in highly reducing environments, due to its excellent thermal stability and resistance to slags.

The anode and cathode must withstand high temperatures (>1600° C.), the chemically aggressive molten regolith, a high electric potential and the formation of atomic oxygen on the anode surface and often consist of noble metals such as iridium, molybdenum, Pt—Rh alloy or platinum, or conductive ceramic materials.

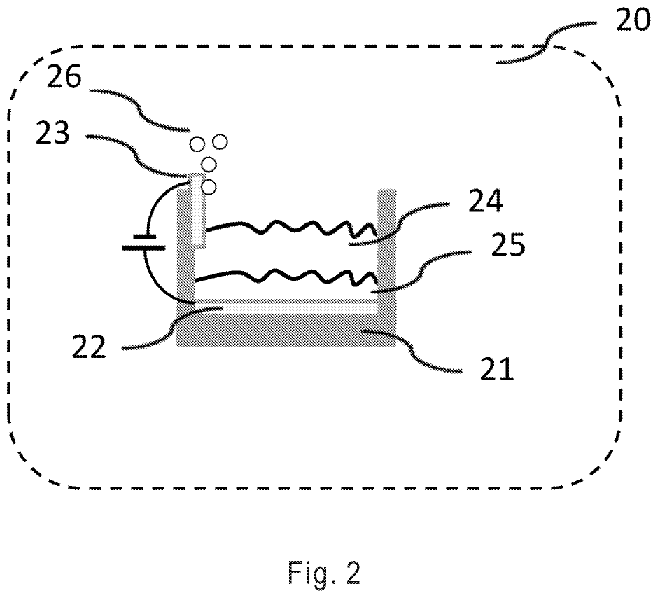

Reference is made to FIG. 2, showing a schematic representation of a cell 20, comprising a crucible 21, a cathode 22 and an anode 23. Regolith 24 is added to the crucible and heated to its melting point. Iron (Fe⁰) 25 accumulates on the cathode 22 and oxygen (O_{2(g)}) 26 is released from the anode 23.

Oxygen extraction from liquid regolith has been demonstrated, with previous attempts conducted using an electric potential of 0.8V, an Iridium anode and conducted at the melting temperature of the regolith. Oxygen was released on surface of the Iridium anode. The use of Iridium is not viable on the moon, due to high cost and high weight when considering the high surface area for the high current density needed.

### Design and Preparation of the Liquid Anode for Regolith Oxidation

The present invention demonstrates the use of a three liquid layers array. The use of the array demonstrates an economically and chemically efficient process to extract the oxygen from regolith.

The requirements/characteristics of a Liquid Anode:
1. The material(s) has a reduction potential higher than the oxidation potential of the reaction, higher than 0.8V. In some embodiments, the material has a potential of at least 0.9V.
2. Chemically inert to oxygen at the working temperature (up to 2000° C.).
3. Slow diffusion rates with the regolith—to hinder the mixing of the anodic material with the melted regolith blocking the loss of material and improving efficiency.
4. Does not form emulsions (with the Milton regolith) on the surface of the anode, that can affect anodic resistance and therefore the working potentials.
5. Must not form chemical bonds with the components of the regolith.
6. High boiling point of at least 500° C. then that of the process. In some embodiments, the material has a boiling temperature of at least 2200° C.
7. Different (Higher or lower) liquid density then that of the melted regolith. The cell can be structured to accommodate both heavier (positioned under the stock material) and lighter (positioned above the molten regolith). The density of the solid regolith is 2.7 gr*cm³.

A number of candidates have been identified that meet some of the requirements, such as silver, gold, platinum, rhodium, tantalum and other precious metals will be usable as alloys of the same.

The anode could be a liquid or at least partially liquid. In some embodiments, the anode exists in an equilibrium between a solid and a liquid phase. In some embodiments, the solid is characterized as a crystal. In an embodiment where the anode comprises an alloy of platinum and gold, the anode could exist as a suspension of gold/platinum particles in a platinum and gold solution.

In a preferred embodiment, the anode material should have a low cost and low weight to lower travel costs.

### Proposed Cell Structures

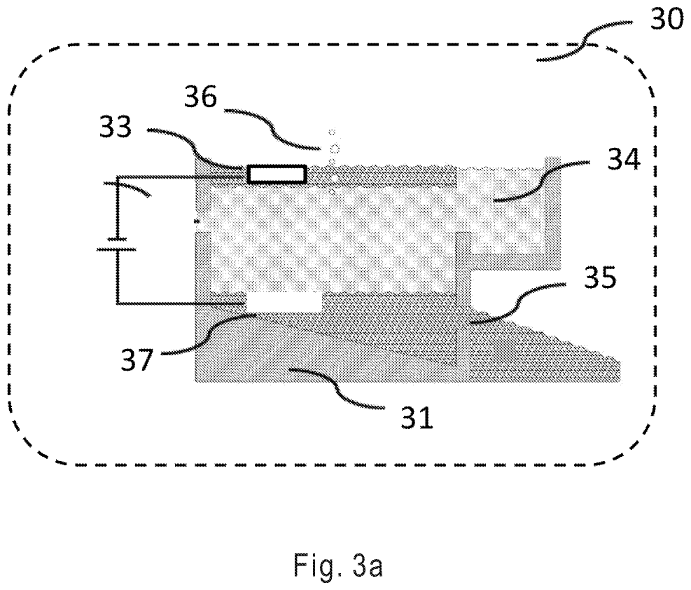

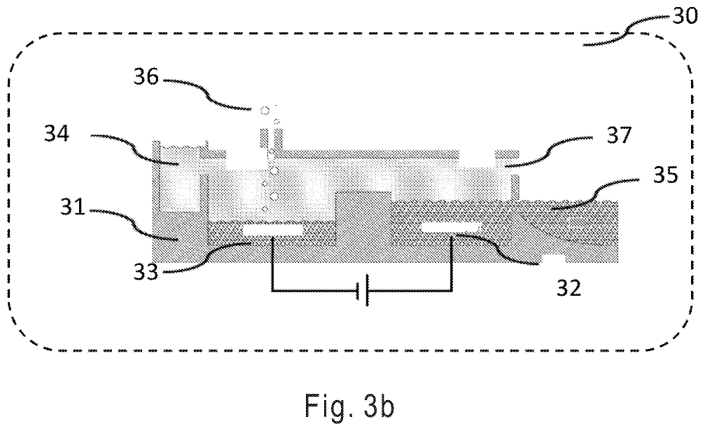

Reference is made to FIG. 3a, presenting an embodiment cell 30 that functions similarly to a battery, with an anode constructed from a material that is lighter then melted regolith. The crucible 31, is constructed from a resistant material, while the cathode 32 is solid and the anode 33 is liquid and has a lower density than the regolith. Regolith 34 is added to the crucible and heated to its melting point. Iron (Fe⁰) 35 accumulates on the cathode 32 and exits the cell from the lower end of a gradient. Oxygen (O_{2(g)}) 36 is released from the anode 33. Spent molten regolith exits the cell 37, making room for new stock material.

Reference is made to FIG. 3b, presenting a second embodiment of the cell 30. The crucible 31, is constructed from a resistant material, while the cathode 32 is solid and the anode 33 is liquid and has a higher density than the regolith. Regolith 34 is added to the crucible and heated to its melting point. Oxygen (O_{2(g)}) 36 is released from the anode 33. Iron (Fe⁰) 35 accumulates on the cathode 32 and exits the cell from the lower end of the cell. Spent molten regolith exits the cell from the lower end of the cell 37, making room for new stock material.

### EXPERIMENTAL

### Example 1

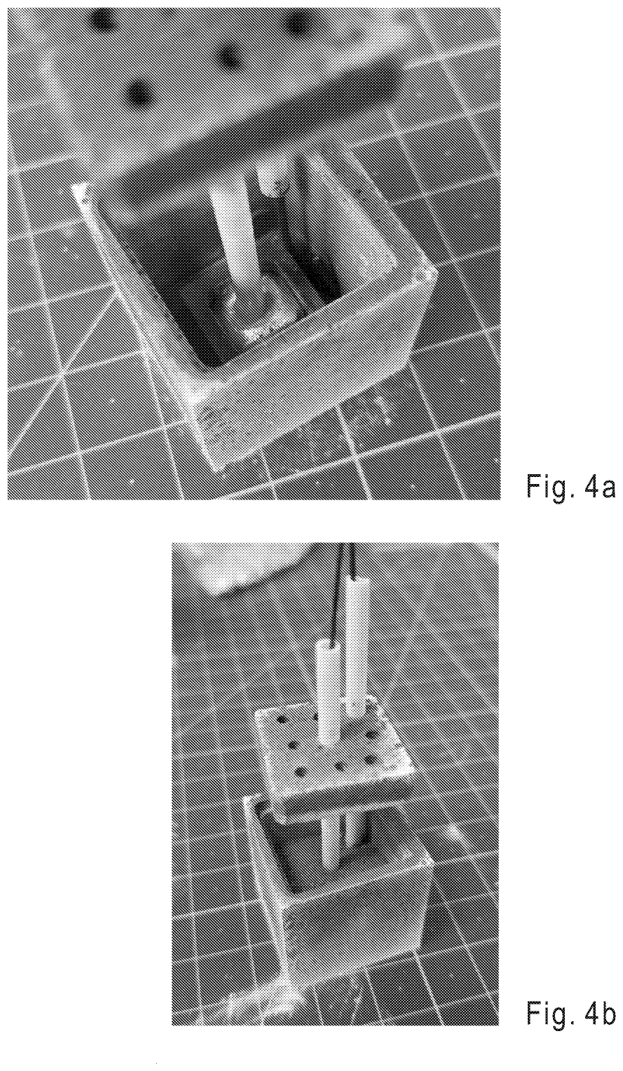

Reference is made to FIG. 4(a, b), showing a cell comprising a crucible constructed of boron nitride (BN) cylinder (diameter 5 cm, height 10 cm), a cathode constructed from molybdenum (Mo) wire diameter of 1 mm and an anode constructed from is iridium (Ir) wire diameter of 1 mm. The cathode and anode are placed 10 mm apart. The lunar regolith used is exolith (trademark) LMS-1 made by university of central Florida. The electrodes are inserted inside a protective alumina tubes (2 mm diameter) for heat protection. The tip of the wires is inserted 1 mm above the crucible surface and lunar regolith simulant covers the tip and is added until 3 mm below the opening of the crucible. The oven is first heated to 300° C. under vacuum conditions for 3 h to allow for moisture to escape the regolith and the crucible. After pre-treatment is concluded the oven is heated at about 15 deg/min until reaching 1600 Celsius. When working temperature is achieved the electrochemical process is activated using ‘solarton’ potentiostat. A cyclic voltammetry of −2 volts to 2 volts is activated. The oven (across 1800) is operated under Ar atmosphere and the gas output is monitored by a mass flow meter (AALBORG) and zirconia oxygen sensor.

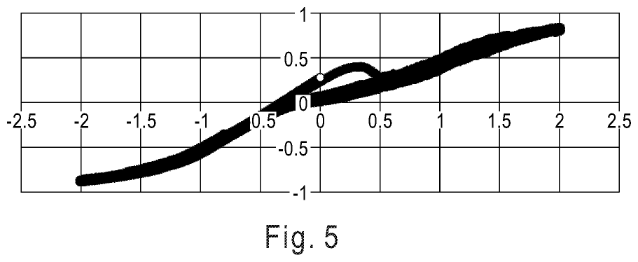

Oxygen evolution and production can be detected indirectly by Electrochemical spectrogram. FIG. 5 shows the result of a cyclic voltammetry sweep and demonstrates the changes to conductivity of the molten oxides. A peak is observable as the oxidation of negative charged oxygen ions at ˜0.25V;

### Example 2

A cell (as per FIG. 4a,b), comprises a crucible constructed from a boron nitride (BN) cube (height 10 cm, dynamiter 5 cm), a molybdenum (Mo) cathode (1 mm diameter) and a molten silver (Ag) anode (further connected to a Mo current collector).

The lunar regolith used is exolith (trademark) LMS-1 made by university of central Florida. The tip of the wires is inserted 1 mm above the crucible surface and lunar regolith simulant covers the tip and is added until 3 mm below the opening of the crucible. The oven is first heated to 300° C. under vacuum conditions for 3 h to allow for moisture to escape the regolith and the crucible. After pre-treatment is concluded the oven is heated at about 15 deg/min until reaching 1600° C. When working temperature is achieved the electrochemical process is activated using ‘solarton’ potentiostat. A cyclic voltammetry of −2 volts to +2 volts is activated. The oven is operated under Ar atmosphere and the gas output is monitored by a mass flow meter (AALBORG) and zirconia oxygen sensor.

20 grams of regolith is placed in the crucible and A sweep of voltages from −2 to +2 volts is performed.

The electrochemical process is performed under Ar inert gas atmosphere. The Ar serves as a carrier gas for the oxygen which is being produced on the anode and helps to extract the oxygen quickly to prevent it from chemically reacting with different component.

1-24. (canceled)

25. A cell for extracting oxygen from lunar regolith, comprising
a. a cathode;
b. an anode;
c. a crucible;
wherein said anode is at least partially liquid and characterized by at least one of the following:
i. a reduction potential of at least 0.8 volts;
ii. being inert to oxygen at temperature of up to 1600° C.;
iii. not forming emulsions with molten regolith;
iv. having a boiling point of at least 1600° C.;
v. having a liquid density higher than that of molten regolith;
vi. having a liquid density lower than that of the molten regolith.

26. The cell of claim 1, wherein said crucible is constructed from a material characterized by at least one of the following:
d. chemical resistant to said lunar regolith;
e. does not react with said molten lunar regolith;
f. does not decompose at a temperature of up to 1600° C.;
g. does not evaporate at a temperature of up to 1600° C.

27. The cell of claim 25, wherein said crucible is constructed from a material selected from a group consisting of zirconium oxide, hafnium oxide, boron nitride, silicon nitride, tantalum hexaboride, hafnium boride, magnesium oxide, silicon carbide, silicon nitride and zirconium diboride.

28. The cell of claim 25, wherein said anode is selected from a group consisting of palladium, lead, silver, gold, platinum, tantalum, or an alloy of said materials.

29. The cell of claim 25, wherein said anode is characterized as a liquid, a solution, an emulsion or as a suspension.

30. The cell of claim 25, wherein said cathode comprises a metal selected from a group consisting of Mo, Pt, Ir, Rh and Fe.

31. The cell of claim 25, additionally comprising a system for heating said cell to a temperature of 1600° C.

32. The cell of claim 25, additionally comprising means for collecting and or storing said oxygen.

33. The cell of claim 25, additionally comprising a system for removing used lunar regolith.

34. The cell of claim 25, additionally comprising a system for adding said lunar regolith to said cell.

35. The cell of claim 25, additionally comprising a system for heating said lunar regolith.

36. The cell of claim 25, additionally comprising a system for generating an electric current.

37. A method of obtaining oxygen from lunar regolith, comprising steps of:
a. obtaining a cell, comprising:
i. a cathode;
ii. an anode;
iii. a crucible;
b. adding lunar regolith to said cell;
c. heating said regolith to at least the melting point of said regolith;
d. generating an electric current of 2-10 volts;
e. collecting oxygen from said anode;
wherein said anode is characterized at least partially as a liquid and is characterized by at least one of the following:
i. a reduction potential of at least 0.8 volts;
ii. being inert to oxygen at temperature of up to 1600° C.;
iii. not forming emulsions with molten regolith;
iv. having a boiling point of at least 1600° C.;
v. having a liquid density higher than that of molten regolith;
vi. having a liquid density lower than that of the molten regolith.

38. The method of claim 37, wherein said lunar regolith is characterized as comprising iron oxide.

39. The method of claim 37, additionally comprising a step of removing used lunar regolith.

40. The method of claim 37, wherein said crucible is constructed from a material characterized by at least one of the following:
a. does not decompose at a temperature of up to 1600° C.;
b. does not evaporate at a temperature of up to 1600° C.

41. The method of claim 37, wherein said anode comprises a metal selected from a group consisting of palladium, lead, silver, gold, platinum, tantalum, or any of their alloys.

42. The method of claim 37, wherein said cathode comprises a transition metal.

43. The method of claim 37, wherein said cathode comprises a metal selected from a group consisting of Mo, Pt, Ir, Rh and Fe.
